(19) United States
(12) Patent Application Publication
(10) Pub. No.: US 2004/0199911 A1
(43) Pub. Date: Oct. 7, 2004

(54) Apparatus and method for upgrading execution code of the portable memory device

(75) Inventors: Hai-Cha Lo, Taipei (TW); Yao-Wen Hsu, TaiNan (TW)

Correspondence Address: BRUCE H. TROXELL, SUITE 1404, 5205 LEESBURG PIKE, FALLS CHURCH, VA, 22041, US

(73) Assignee: InCOMM Technologies Co., Ltd.

(21) Appl. No.: 10/813,028

(22) Filed: Mar. 31, 2004

(30) Foreign Application Priority Data
Apr. 4, 2003 (TW) 92107676

(51) Int. Cl. G06F 9/44

(52) U.S. Cl. 717/171

(57) ABSTRACT

The invention provides an apparatus and a method for upgrading an execution code of a portable memory device. The apparatus stores the execution code in a programmable unit of the portable memory device. While this portable memory device is connected to an external host, an execution code upgrading mechanism stored in the external host will check if there is a newer version of the execution code stored in the external host. If there is, the external host will generate an upgrading signal, delete the original execution code stored in the portable memory device, and overwrite the execution code at the same memory location of the portable memory device with the new version of execution code stored in the external host. Then, the portable memory device will operates by using this new version of execution code.

### BACKGROUND OF THE INVENTION

1. Field of the Invention

This invention relates to an apparatus and method for upgrading execution code of a portable memory device, and more particularly, to a portable memory device which can store execution code, wherein, the execution code can be upgraded by an external device.

2. Background of the Invention

Portable memory devices become more and more important these days. Portable memory devices include solid state disk which uses flash memory; Compact Flash Card (CF Card), Memory Stick, Secure Digital (SD Card), MultiMedia Card (MMC), and xD Cards which are flash memory cards; micro hard disk which uses CF or USB interface; and 2.5 inches hard disk which use USB or PCMCIA interface.

The conventional portable memory devices include a non-volatile memory array and a controller. The non-volatile memory array is used to store data and the data can be preserved without external power supply. The non-volatile memory array is generally implemented by the flash memory. It is also able to be implemented by the hard disk. The controller comprises a corresponding circuit and a driving mechanism to drive and access the non-volatile memory array. The driving mechanism can be a command sequencer, which executes the Micro-Code that stored in the hardware. The driving mechanism can also be a controller which executes a Firmware stored in the controller of the portable memory device. The Micro-Code and the Firmware are referred as “Execution Code” in the present invention. Upgrading the execution code is difficult in the conventional portable memory devices.

Taiwanese Patent No. 502209 described that the drive software and the data are stored in the memory array of a flash memory card. Therefore, a memory IC for storing the firmware is not required and the cost of the flash memory card is reduced. However, Taiwan Patent No. 502209 did not describe how the execution code is upgraded. In additions, to store a plurality of versions of execution code in a portable memory device is essential. In Taiwan patent No. 502209, only one version of execution code can be stored in memory array.

### SUMMARY OF THE INVENTION

In view of the above, it is an objective of the present invention to provide an apparatus and method for upgrading execution code of a portable memory device. By means of storing the execution code of the portable memory device into a programmable memory unit, the version of the execution code can be checked and upgraded.

In order to achieve the above objective, the present invention provides an apparatus and method for upgrading the execution code of the portable memory device, by means of storing the execution code of the portable memory device into a programmable memory unit. While connecting this portable memory device to an external host device, an execution code upgrading mechanism stored in the external host device will check if there is a newer version of execution code stored in the external host device. If there is, the external host device will output an upgrading signal into the portable memory device, delete the original execution code which in the programmable memory unit, and, at, store the new version of execution code of the external host device to the same location of the programmable memory unit. Then, the portable memory device is able to operate with the new version of the execution code. Thus, the objective of upgrading the version of execution code of the portable memory device can easily be achieved.

Another objective is to provide an apparatus and method for upgrading execution code of the portable memory device. By means of storing different versions of execution code at different locations of a memory array, this portable memory device can stored more than one version of the execution code simultaneously. While upgrading the execution code, the external host device can check the memory location of the oldest version and replace with the newest version of the execution code at the same location. An embodiment is that the external host device can communicate with a remote server through the internet and download and download the new version of the execution code and the upgrading mechanism.

Other objectives and advantages of the system shall become apparent from the following description of the invention.

The present invention is illustrated by way of example and not limited to the figures of the accompanying drawings, in which:

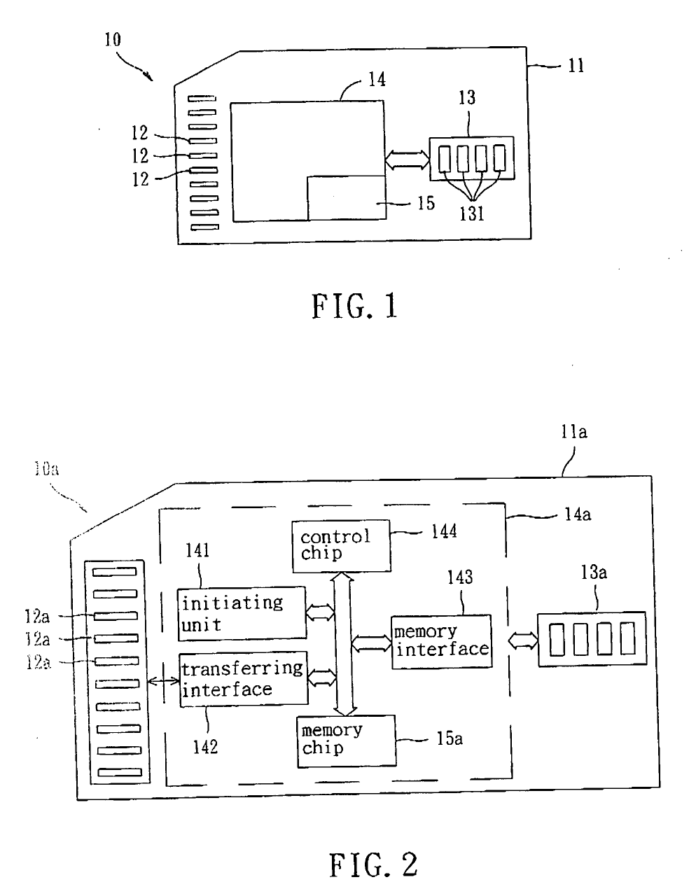

FIG. 1 shows the first preferred embodiment of the portable memory device of the present invention.

FIG. 2 shows the second preferred embodiment of the portable memory device of the present invention.

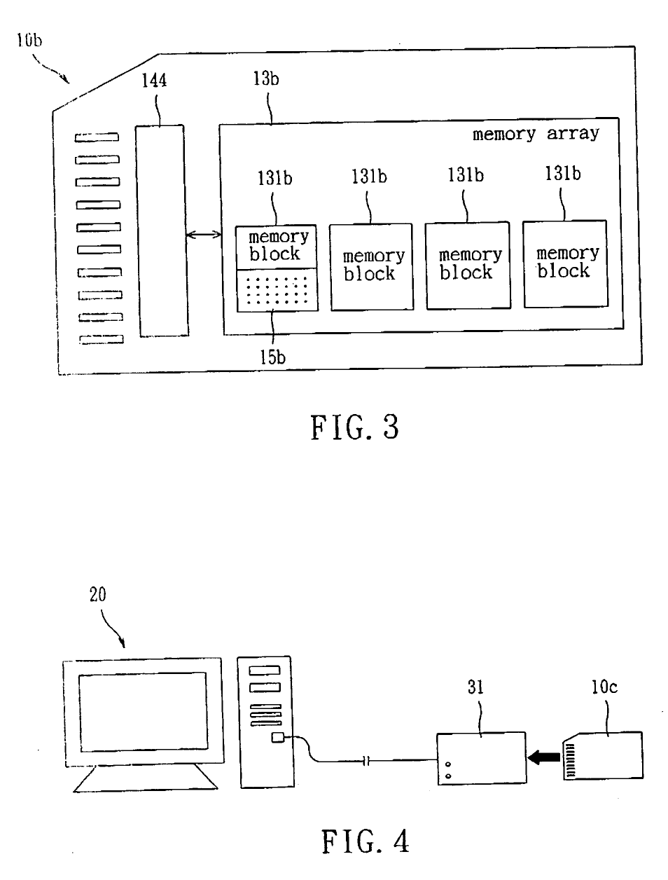

FIG. 3 shows the third preferred embodiment of the portable memory device of the present invention.

FIG. 4 shows a structure of the portable memory device and an external host device for upgrading the execution code.

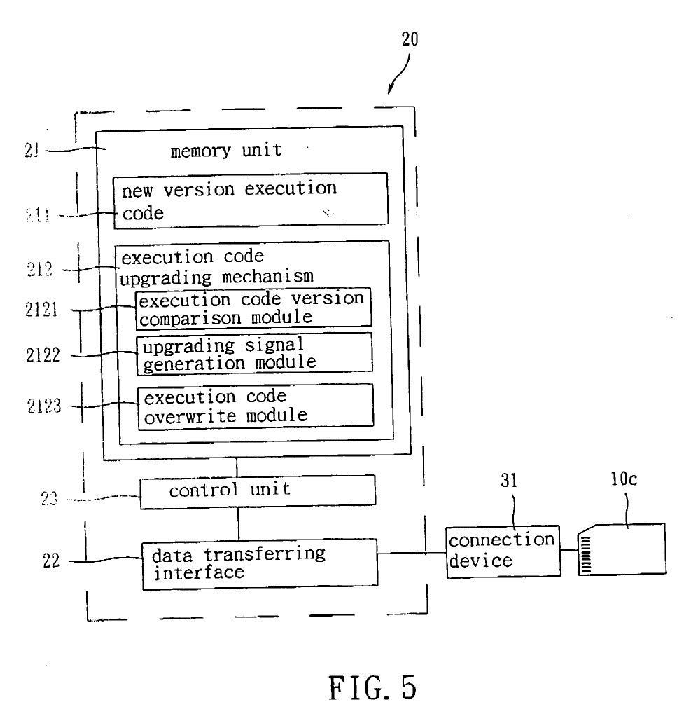

FIG. 5 shows a block diagram and the structure of the external host device of a preferred embodiment of the present invention.

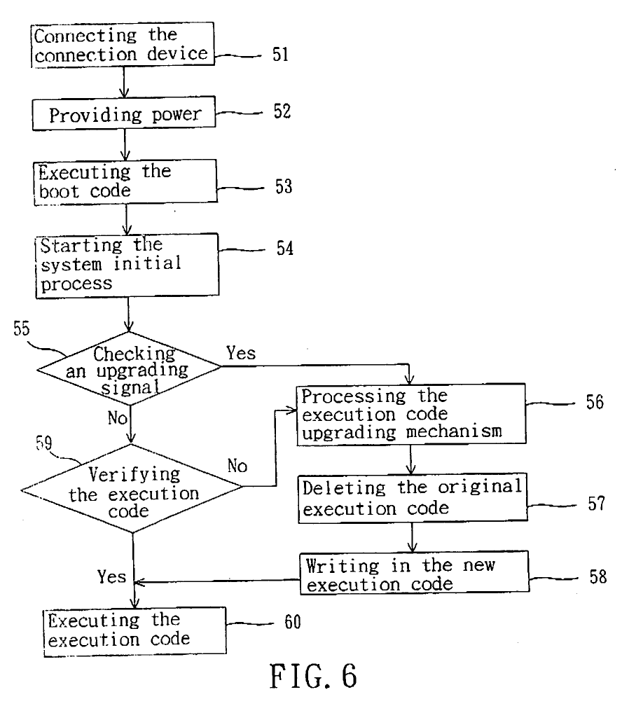

FIG. 6 shows a flowchart of upgrading the execution code of the portable memory device of the present invention.

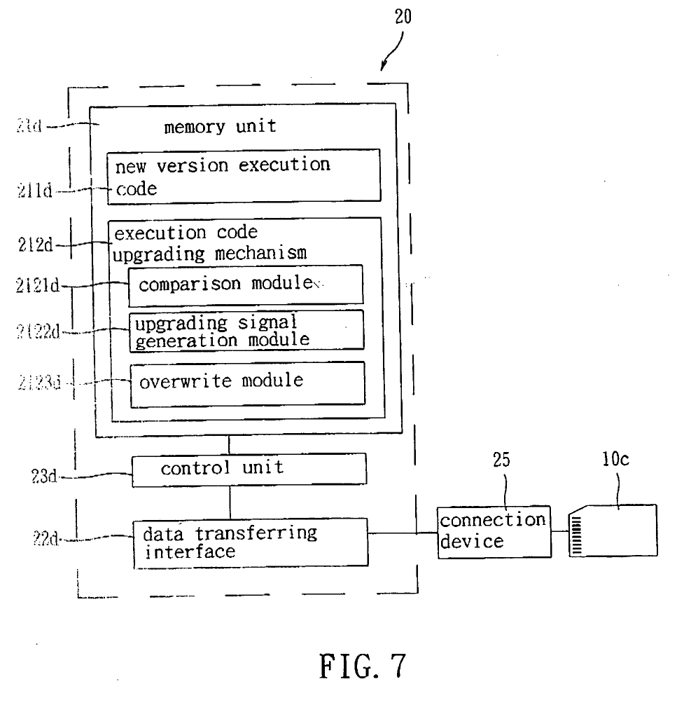

FIG. 7 shows a block diagram and the structure of the external host device of another preferred embodiment of the present invention.

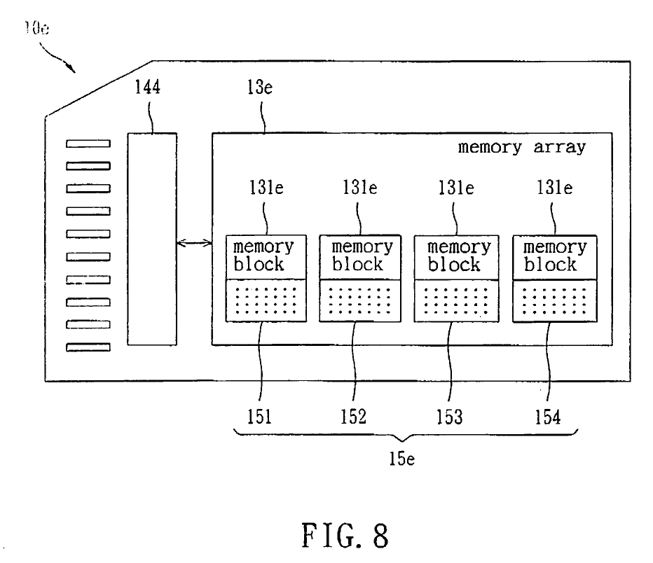

FIG. 8 shows the fourth preferred embodiment of the portable memory device of the present invention.

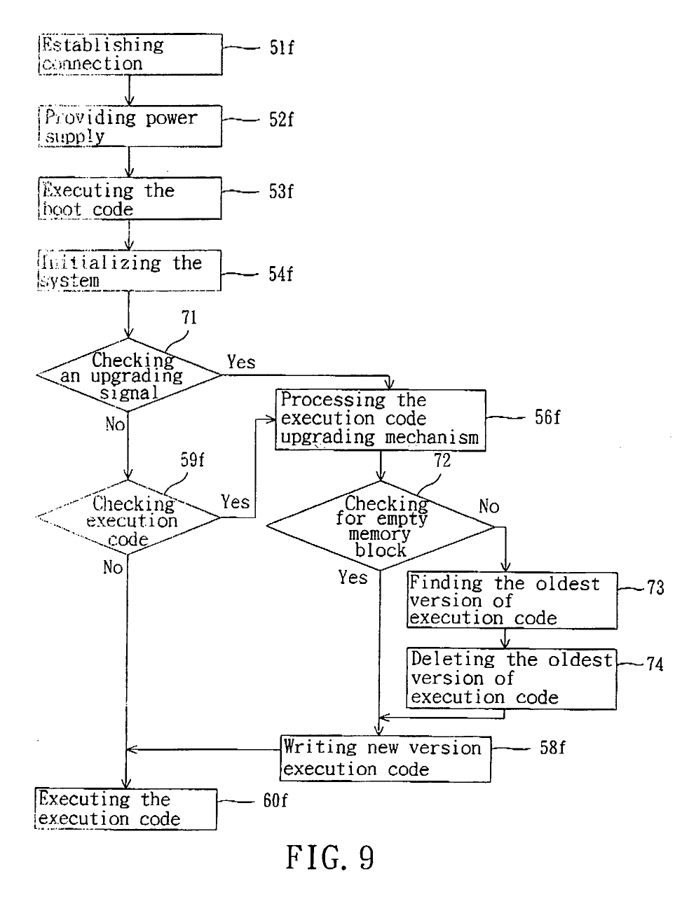

FIG. 9 shows a flowchart of upgrading the execution code of the portable memory device of the present invention.

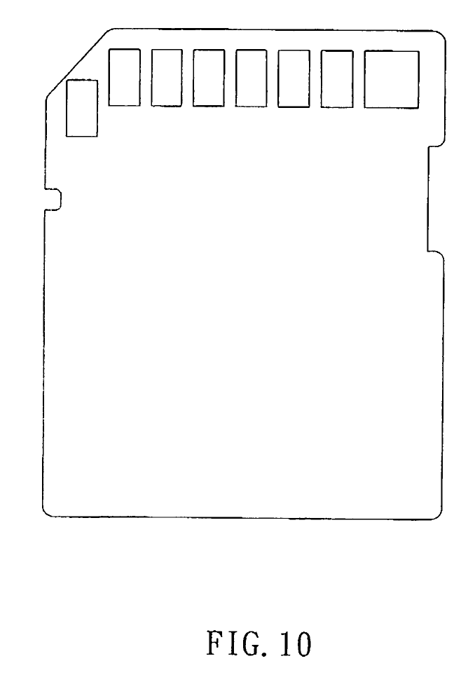

FIG. 10 shows an external structure of a Secure Digital Card (SD Card).

### DETAILED DESCRIPTION OF THE INVENTION

The present invention provides an apparatus and method for upgrading execution code of the portable memory device by means of storing the execution code of the portable memory device into a programmable memory unit. While connecting this portable memory device to an external host device, an execution code upgrading mechanism stored in the external host device will check if there is a newer version of execution code stored in the external host device. If there is, the external host device will output an upgrading signal into the portable memory device, delete the original execution code from the memory unit, and, at the same memory location, replace with the new version of execution code stored in the external host. Then, the portable memory device is able to operate according to the new version of the execution code.

FIG. 1 shows a portable memory device 10 which includes a body 11 with a plurality of external connecting pins 12 for connecting the external host device which is not shown in this figure, a memory array 13, and a controller 14 for controlling the data retrieving between the memory array 13 and the external host device. In this embodiment, the memory array 13 can be a plurality of non-volatile memory chips 131, such as flash memory chips, which can retain data without external power supply. The controller 14 comprises a programmable memory unit 15 which is erasable and programmable. The programmable memory unit 15 is designed for storing the execution code of the portable memory device 10. In this embodiment, the controller 14 is a SOC (System on chip) controller chip. In other words, the programmable memory unit 15 is built (integrated) in the controller 14. The programmable memory unit 15 can be a flash memory circuit, latch circuit, or electrical erasable programmable read only memory (EEPROM) e.t.c..

Please refer to FIG. 2. FIG. 2 shows another embodiment of the portable memory device 10a of the present invention. Elements has been described above will be referred as the same terminology and number with different letters added at the end. The detailed structure and function of these elements will not be restated.

The portable memory device 10a contains a main unit 11a with a plurality of connecting pints 12a, a memory array 13a, and a controller 14a. The differences between the embodiment in FIG. 2 and that in FIG. 1 are that the controller 14a of the embodiment in FIG. 2 comprises of an initiating unit 141, a transferring interface 142, a memory interface 143, an erasable and programmable memory chip 15a, and a controlling chip 144. The initiating unit 141 is a small read-only memory such as MASK ROM which store the code for initiating the controlling chip 144. The transferring interface 142 connects between the connecting pins 12a and the controlling chip 144 and is served as the interface for data transferring into the controller 14a. The memory interface 143 connects between the memory array 13a and the controlling chip 144, for transferring data between the controlling unit 144 and the memory array 13a. The erasable and programmable memory chip 15a stores the execution code of the portable memory device which can be flash memory or EEPROM. The erasable and programmable memory chip 15a is preferable to be an independent memory chip.

FIG. 3 shows a third embodiment of the portable memory unit 10b of the invention. Most of the elements in the portable memory unit 10b are similar to those in the portable memory unit 10 that will not be re-stated. The difference between the portable memory unit 10b and 10 is that the memory unit 15b of the portable memory unit 10b is not built (integrated) in the controlling unit 144. The memory unit 15b is a portal location of the memory array 13b. In other words, the memory chip 131b has a plurality of memory blocks 131b and the memory unit 15b is one of the plurality of memory blocks 131b. The memory unit 15b in the memory array 13b can be in the lucked status to prevent the execution code in the memory unit 15b.

FIG. 4 and FIG. 5 show the structure of the portable memory device 10c and an external host device 20 for upgrading the execution code. The FIG. 5 shows the block diagram of the function and the internal structure of the external host device 20. As described in FIGS. 1, 2 and 3, the execution code are stored at the memory unit (10; 10a; 10b) and the execution code can be upgraded under the control of the external host device 20. The external host device 20 can be a PC, a Portable computer, a Tablet PC, a PDA, and other special computers. The external host device contains a memory unit 21, a data transferring interface 22, and a control unit 33.

The external host device 20 connects to the portable memory device 10c with a connection device 31. In this embodiment, since the portable memory device 10c is a flash memory card, the connection device 31 is a card reader. While inserting the flash memory card into the card reader, the electrical circuit can be connected and the data can be transferred. In another embodiment, the portable memory device is a USB solid state disk, and the connection device 31 is a USB connector.

The memory unit 21 stored at least one new version execution code 211 and the execution code upgrading mechanism 212. The execution code upgrading mechanism 212 contains an execution code version comparison module 2121, an upgrading signal generation module 2122 and an execution code overwrite module 2123. In this embodiment, the external host device 20 is a PC; the memory unit 21 is a hard disk; the new version execution code 211 and the upgrading mechanism 212 are executable upgrade patch files stored in the hard disk. While the PC executing this executable upgrade patch files, the execution code upgrading mechanism 212 is initialized. Wherein, the execution code version comparison module 2121 compares the execution code store in the portable memory device 10c with the new version execution code 211 stored in the external host device 20. While the new version execution code 211 of the external host device 20 is different and newer than the version of execution code of the portable memory device 10c, the execution code upgrading mechanism 212 is initialized. Otherwise, the execution code upgrading mechanism 212 will show no information or show “no need for upgrading” in the external host device 20, and the portable memory device 10c executing the original execution code. If upgrading is needed after the comparison, the upgrading signal generation module 2122 will generate a upgrading signal according the result of comparison, and stop the portable memory device 10c executing the original execution code. When the new version of execution code upgrading procedure is finished, the portable memory device 10c will operate with the new version of execution code. The objective of upgrading execution code is achieved.

The data transferring interface 22 connects to the portable memory device 10c with the connection device 31 and transfers data via a predetermined communication protocol. In this embodiment, the connection device 31 is a card reader which has a USB interface. Therefore, the data transferring interface 22 communicates with both the portable memory device 10c and the external host device 20 by using the standard USB communication protocol. The control unit 23 controls the memory unit 21 and the data transferring interface 22. The control unit 23 can be initialized by the execution code upgrading mechanism 212 and upgrade the execution code of the portable memory device 10c.

As shown in FIG. 4, the new version execution code 211 and the execution code upgrading mechanism which are stored as a software in the external host device 20 can not only be duplicated from disks, CDs and other storing medias, but also be downloaded from a remote server 33 through the internet 32.

In this embodiment, the execution code upgrading mechanism 212 will automatically check the version of execution code every time when the portable memory device 10c connects to the external host device 20. Since the execution code upgrading mechanism 212 is stored as a permanent resident program in the external host device 20, this permanent resident program will periodically inform the user, search and download the newest version of execution code 211 and the execution code upgrading mechanism 212 from the remote server 33 through the internet 32. In additions, when a portable memory device with an older version of execution code connects to the external host device 20, the execution code upgrading mechanism 212 stored as a permanent resident program will automatically execute an upgrading procedure.

Please refer to FIG. 6, FIG. 6 shows a first preferred flowchart for upgrading the execution code of the portable memory device. The method for upgrading the execution code of the portable memory device comprises steps of:

A. Providing a portable memory device, an external host device and a connection device: The portable can be a flash memory card, the external host device can be a Personal Computer (PC) and the connection device can be a card reader. The external host device comprises a new version execution code and an execution code upgrading mechanism, wherein, the new version execution code is stored in an erasable and programmable memory unit. The erasable and programmable memory unit can be an independent memory chip or a memory array or a memory block in a controller.

B. Establishing connection between the portable memory device and the external host device: The step of establishing connection further comprises steps of B1, B2, and B3.

B1: (step 51) Connecting the connection device to the external host device, executing the execution code upgrading mechanism, and inserting the portable memory device to the connection device; wherein, the external host device communicates with the portable memory device through the connection device with a predetermined communication protocol which can be a USB protocol;

B2: providing a power supply of the portable memory device from the external host device (step 52);

B3: executing the boot code (step 53): The portable memory device executes the stored boot code to start the system initial process (step 54);

C: Checking an upgrading signal (step 55): If the upgrading signal is asserted, the execution code upgrading mechanism (step 56) is conducted, that is the execution code overwrite module in the external host device writes the new version execution code stored in the external host device into portable memory device and verify the transferred execution code, and then the new version execution code replaces the execution code of the portable memory device. If the upgrading signal does not exist, step 59 is processed. Step 55 further comprises steps of C1 and C2:

C1: The version comparison module in the external host device reads the version of the execution code in the portable memory device and compares this with the new version execution code stored in the external host device.

C2: If the new version execution code in the external host device is newer then the version of execution code in the portable memory device, the upgrading signal generation module generates an upgrading signal. If the new version execution code in the external host device is not newer then the version of execution code in the portable memory device, the upgrading procedure will not be executed and step 59 will be proceeded.

D. Deleting the original execution code (step 57): The original execution code in the programmable memory unit of the portable memory device is deleted, and

E. Store the execution code into the same programmable memory unit of the portable memory device (step 58), and step 60 is proceeded,

F. Verifying the execution code (step 59): If the execution code in the programmable memory unit is correct, step 60 will be proceeded. If the execution code in the memory unit is not correct such as in conditions that the programmable memory unit contains no execution code, incomplete execution code or incorrect execution code, step 56 will be proceeded to conduct the execution upgrading mechanism.

G. Execute the execution code (step 60): Execute the execution code stored in programmable memory unit of the portable memory device to perform the memory device function.

According to the steps described above, the execution code in the portable memory device can be easily upgraded.

FIG. 7 shows the internal structure of the external host device 20d of another embodiment. In this embodiment, the internal structure of the external host device 20d is similar to that in the previous embodiment of FIG. 5. The external host device 20d also contains a memory unit 21d, a data transferring interface 22d, and a control unit 23d. The memory 21d also stores at least a new version execution code 211d and an execution code upgrading mechanism 212d. The execution code upgrading mechanism 212d contains at least an execution code version comparison module 2121d, an upgrading signal generation module 2122d and an execution code overwrite module 2123d. The embodiment shown in FIG. 7 is different from the embodiment shown in FIG. 5 because the connection device 25 in FIG. 7 is built-in the external host device 20d. For example, if the portable memory device 10d is a USB solid state disk, the connection device 25 can be a USB slot built-in the external host device 20d. If the portable memory device 10d is a flash memory card, the connection device 25 can be a card reader built-in the external host device 20d.

FIG. 8 shows a fourth embodiment of the portable memory device of the invention. The difference between the fourth embodiment of the portable memory device 10e in FIG. 8 and the third embodiment in FIG. 7 is that, in the fourth embodiment, the memory array 13e comprises a plurality of memory blocks 151, 152, 153, and 154 of the erasable and programmable memory unit 15e. Each of the memory blocks of the erasable and programmable memory unit 15e can store the execution code which has the different/same versions. The memory blocks 151, 152, 153 and 154 can be in the lucked status to prevent the execution code to be deleted. In the embodiment the portable memory device 10e can store a plurality of the execution code which have a different versions for fitting other different applications. For example, the portable memory device 10e can communicate with other different peripherals by different versions of the execution code.

Please refer to FIG. 9, FIG. 9 shows a preferred flowchart for upgrading the execution code of the fourth embodiment of the portable memory device. Elements has been described above will be referred as the same terminology. The detailed structure and function of these elements will not be repeated.

The preferred method comprises steps of: establishing connection (step 51f), providing power supply (step 52f), executing the boot code (53f), initializing the system (step 54f), writing new version execution code (step 58f), checking execution code (59f), and executing the execution code (step 60f).

This embodiment is different from that shown in FIG. 6 in the following aspects. While finishing the initializing the system (step 54f), the step of checking an upgrading signal (step 71) is proceeded directly. In this checking an upgrading signal step (step 71), the execution code upgrading mechanism in the external host device will check the newest version of execution code of the portable memory device and retrieve this newest version of execution code from the portable memory device. The execution code upgrading mechanism then compares this retrieved newest version of execution code with the version of execution code stored in the external host device. If the version of execution code stored in the external host device is newer, the upgrading signal generation module in the external host device will generate an upgrading signal and step 56f is proceeded. If the version of execution code stored in the external host device is not newer, step of upgrading will not be performed and the step 59f is proceeded directly.

In additions, after the upgrading signal is received and the execution code upgrading mechanism is initialized (step 56f), the step of checking whether the memory block is empty (step 72). In step 72, the execution code upgrading mechanism in the external host device checks each the memory block 151, 152, 153, and 154 in the memory chip 131e of the portable memory device. If a memory block is empty (available), the step 58f is proceeded, wherein the external host device writes the execution code into the memory block. If no memory block is empty, the step 73 is proceeded, wherein the memory block of the oldest version execution code in the portable memory device is obtained. Then step 74 is proceeded, wherein the oldest version execution code is deleted. Then, the step 58f is proceeded, wherein the new version execution code in the external host device is written into the memory block which originally stored the oldest version execution code.

FIG. 10 shows the specification of a SD flash memory card. The embodiments of the portable memory device can be the SD flash memory card. The external structure of the SD flash memory card is illustrated in FIG. 10. However, this embodiment does not limit the application of this invention.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for upgrading an execution code of a portable memory device, wherein said execution code is stored in a programmable non-volatile memory unit of said portable memory device, said method comprising:
(a) providing a host computer, said host computer having a first execution code and a driver upgrading mechanism;
(b) establishing a communicating link between said host computer and said portable memory device;
(c) checking a upgrading signal, and restoring said first execution code of said host computer to said programmable non-volatile memory unit of said portable memory device according to said upgrading signal; and
(d) starting said portable memory device according to said upgraded execution code of said portable memory device.

2. The method of claim 1, wherein the step of establishing said communicating link further comprises:
(b1) connecting said portable memory device and a connecting device, wherein said connecting device transfers data between said portable memory device and said host computer by a predetermined protocol;
(b2) providing a power source to said portable memory device from said host computer.

3. The method of claim 1, wherein the step of said checking said upgrading signal comprises:
(c1) reading a version of said execution code of said portable memory device by said host computer, and comparing said version of said execution code of said portable memory device with a version of said first execution code of said host computer; and
(c2) outputting said upgrading signal from said host computer when said version of said first execution code of said host computer is newer than said version of said execution code of said portable memory device.

4. The method of claim 1, wherein the step of said restoring said first execution code comprises:
(d1) the execution code overwrite module in the external host device writes the new version execution code stored in the external host device into portable memory device and verify the transferred execution code;
(d2) deleting said execution code stored in said programmable non-volatile memory unit of said portable memory device; and
(d3) writing said first execution code of said host computer in said programmable non-volatile memory unit of said portable memory device.

5. The method of claim 1, wherein said portable memory device is a solid state disk.

6. The method of claim 1, wherein said host computer links to a remote server through a network and downloads a new version of said execution code and a file contained said execution code upgrading mechanism over said network.

7. The method of claim 1, wherein said host computer comprises:
a memory device for storing at least one said execution code and said execution code upgrading mechanism of said host computer, wherein said execution code upgrading mechanism comprises a execution code version comparing module, a upgrading signal generating module and execution code writing module; and
a transfer interface for establishing said communicating link with said portable memory device and transferring data by said predetermined protocol, and
a control unit, coupled to said memory device and said transfer interface, for controlling said memory device and said transfer interface, being able to be driven by said execution code upgrading mechanism, and upgrading said execution code of portable memory device.

8. The method of claim 1, wherein said portable memory device further comprises a control chip, wherein said programmable non-volatile memory unit builds in said control chip.

9. The method of claim 1, wherein said portable memory device stores a plurality of execution codes which are in different versions, said step of said checking said upgrading signal comprises:
(cc1) reading a newest version of said execution codes of said portable memory device by said host computer, and comparing said newest version of said execution code of said portable memory device with a version of said first execution code of said host computer;
(cc2) outputting said upgrading signal from said host computer when said version of said first execution code of said host computer is newer than said newest version of said execution code of said portable memory device;
(cc3) checking a empty memory block of said portable memory device, and writing said first version of said execution code of said host computer in said empty memory block of said portable memory device, and jumping the step of (d);
(cc4) checking a memory block stored an oldest version of said execution code of said portable memory device, deleting said oldest version of said execution code, and writing said drive code of said host computer into said memory block.

10. The method of claim 1, wherein said programmable non-volatile memory unit is an independent memory chip.

11. The method of claim 1, wherein said portable memory device comprises a programmable memory array for storing external data, said programmable non-volatile memory unit is a portion of said programmable memory array.

12. An apparatus for upgrading a execution code of a portable memory device, wherein said execution code is stored in a programmable non-volatile memory unit of said portable memory device, comprising:
a connection device coupling to said portable memory device;
a host computer, comprising:
a memory device for storing at least one said execution code and said execution code upgrading mechanism of said host computer, wherein said execution code upgrading mechanism comprises a execution code version comparing module, a upgrading signal generating module and a execution code writing module,
wherein said execution code version comparing module compares a version of said execution code of said portable memory device with a version of a first execution code of said host computer and produces a result of comparison,
wherein said upgrading signal generating module generates a upgrading signal according to said result of comparison,
wherein said execution code writing module initializes a procedure for writing said first execution code of said host computer into said programmable non-volatile memory unit of said portable memory device;
a transfer interface for establishing said communicating link with said portable memory device and transferring data by a predetermined protocol, and
a control unit, coupled to said memory device and said transfer interface, for controlling said memory device and said transfer interface, being able to be driven by said execution code upgrading mechanism, and upgrading said execution code of portable memory device.

13. The apparatus of claim 12, wherein said portable memory device is a solid state disk.

14. The apparatus of claim 12, wherein said host computer links to a remote server through a network and downloads a new version of said execution code and a file contained said execution code upgrading mechanism over said network.

15. The apparatus of claim 12, wherein said portable memory device further comprises a control chip, wherein said programmable non-volatile memory unit builds in said control chip.

16. The apparatus of claim 12, wherein said portable memory device comprises a plurality of memory blocks of said programmable non-volatile memory unit, each of said memory blocks stores a plurality of said execution codes which are in different versions, said execution code writing module initializes said procedure for writing said first execution code of said host computer into said memory block which stores an oldest version of said execution code according to said upgrading signal.

17. The apparatus of claim 12, wherein said programmable non-volatile memory unit is an independent memory chip.

18. The apparatus of claim 12, wherein said portable memory device comprises a programmable memory array for storing external data, said programmable non-volatile memory unit is a portion of said programmable non-volatile memory array.

19. The apparatus of claim 12, wherein portable memory device is a memory card and said connection device is a memory card reader.

20. The apparatus of claim 12, wherein said connection device builds in said host computer.

21. A host computer for upgrading an execution code of a portable memory device, wherein said execution code is stored in a programmable non-volatile memory unit of said portable memory device, comprising:
a memory device for storing at least one said execution code and said execution code upgrading mechanism of said host computer, wherein said execution code upgrading mechanism comprises a execution code version comparing module, a upgrading signal generating module and a execution code writing module,
wherein said execution code version comparing module compares a version of said execution code of said portable memory device with a version of a first execution code of said host computer and produces a result of comparison,
wherein said upgrading signal generating module generates an upgrading signal according to said result of comparison,
wherein said execution code writing module initializes a procedure for writing said first execution code of said host computer into said programmable non-volatile memory unit of said portable memory device;
a connection device coupling to said portable memory device; and
a control unit, coupled to said memory device, for controlling said memory device, being able to be driven by said execution code upgrading mechanism, and upgrading said execution code of portable memory device.

22. The host computer of claim 21, wherein said host computer links to a remote server through a network and downloads a new version of said execution code and a file contained said execution code upgrading mechanism over said network.

23. The host computer of claim 21, wherein said portable memory device comprises a plurality of memory blocks of said programmable non-volatile memory unit, each of said memory blocks stores a plurality of said execution codes which are in different versions, said execution code writing module initializes said procedure for writing said first execution code of said host computer into said memory block which stores an oldest version of said execution code according to said upgrading signal.
